(19) United States
(12) Patent Application Publication
(10) Pub. No.: US 2008/0133217 A1
(43) Pub. Date: Jun. 5, 2008

(54) METHOD AND APPARATUS FOR LEARNING ENGLISH VOCABULARY AND COMPUTER ACCESSIBLE STORAGE MEDIUM TO STORE PROGRAM THEREOF

(75) Inventor: Yuan-Chau Chan, Taipei County (TW)

Correspondence Address: J C PATENTS, INC., 4 VENTURE, SUITE 250, IRVINE, CA, 92618, US

(73) Assignee: INVENTEC CORPORATION, Taipei City (TW)

(21) Appl. No.: 11/675,448

(22) Filed: Feb. 15, 2007

(30) Foreign Application Priority Data
Nov. 30, 2006 (TW) 95144447

(51) Int. Cl. G06F 17/28

(52) U.S. Cl. 704/5

(57) ABSTRACT

A method and an apparatus for learning the English vocabulary are provided. First a vocabulary database is provided in the present invention. A word is selected from the database to be taken apart into other alphabet strings. Then, the alphabet strings taken apart from the selected word are searched for in the database to see if they exist in it. If yes, the search results are thus displayed. Hence, the method and the apparatus deepen the impression of the English vocabulary on the users and help them memorize the vocabulary and not easily confuse one word with another.

### CROSS-REFERENCE TO RELATED APPLICATION

This application claims the priority benefit of Taiwan application serial no. 95144447, filed on Nov. 30, 2006. All disclosure of the Taiwan application is incorporated herein by reference.

### BACKGROUND OF THE INVENTION

1. Field of the Invention

The present invention relates to a method and an apparatus for English learning, especially to a learning method and an apparatus for enhancing the memory of the English vocabulary and deepening the impression of the vocabulary on the users.

2. Description of Related Art

As times change, information from all over the world has constantly poured into people's life today through all kinds of channels such as the television, books, newspapers, magazines and internet. As a result, learning a second language has become a trend, and English is the most common choice among different languages. When the general public learns English, faced with huge English vocabulary they usually do not have an effective learning method. To address this need, many books aimed at sorting out the English vocabulary in different ways appear in the market to help learners deal with the problem. Due to the progress in the technology in recent years, the market is even more teeming with all sorts of electronic learning softwares and learning tools. Hence, learning methods are no longer confined to the traditional methods such as book learning or human lecturing. The learners can pick Up the information they need through these learning softwares or learning tools.

Generally the softwares or tools for learning English vocabulary currently available on the market (like an electronic English dictionary) have almost the same functions as the traditional soft copy English dictionaries. For instance, the users use electronic dictionaries to search for vocabulary and list words of relevant meanings, but the electronic dictionaries cannot help the users enhance their memory of the vocabulary. Furthermore, since most softwares or tools available on the market for learning English vocabulary do not have an efficient way to sort out the vocabulary, they fail to substantially assist English teachers with their arrangement of their teaching materials. Therefore, during their arrangement of the teaching materials, without comprehensive references, the teachers have to rely heavily on their own experiences to compile a series of materials. Nevertheless, the vocabulary covered is still not as comprehensive as can be.

### SUMMARY OF THE INVENTION

The present invention provides a method of learning English vocabulary, which takes an English word apart into other alphabet strings so as to enhance memory of the word in a user's mind.

The invention provides a computer accessible storage medium used for storing a computer program. The computer program is applied to a computer system, and the computer system is able to execute each step of the foregoing English vocabulary learning method.

The invention provides an apparatus for learning English vocabulary. The apparatus searches in the database for the alphabet string(s) taken apart from a word and sorts out a set of relevant vocabulary.

The invention provides a method of learning English vocabulary. First, a database containing a plurality of English words is provided. Next, a selected word is set and then taken apart into at least one alphabet string. Then, the alphabet string(s) is/are searched in the database to check whether the alphabet string(s) exist(s) in the database. Finally, the search result(s) is/are displayed.

The invention provides a computer accessible storage medium used for storing a computer program. The computer program is applied to a computer system, and the computer system is thus able to execute the said English vocabulary learning method.

The invention provides an apparatus for learning English vocabulary. The English vocabulary learning apparatus includes a storage medium, an operating unit and a display unit. The storage medium is used for depositing a vocabulary database containing a plurality of English words. The operating unit is used for setting a selected word, taking apart the selected word letter by letter into at least one alphabet string, and searching for the alphabet string(s) in the database. The display unit is used for displaying the search result(s) from the operating unit.

Through taking a word apart into other alphabet strings, searching for the alphabet strings in the database and sorting out a set of relevant vocabulary, the invention deepens the impression of language learning on the users, enhances their memory of the English vocabulary without their easily confusing one word with another

In order to make the aforementioned and other objects, features and advantages of the present invention more comprehensible, preferred embodiments accompanied with figures are described in detail below.

### BRIEF DESCRIPTION OF THE DRAWINGS

FIG. 1 is a block diagram of an English vocabulary learning apparatus according to the first embodiment of the present invention.

FIG. 2 is a flowchart of an English vocabulary learning method according to the first embodiment of the invention.

FIG. 3 is a schematic diagram of the operating frame of the English vocabulary learning method according to the first embodiment of the invention.

FIG. 4 is a flowchart of an English vocabulary learning method according to the second embodiment of the invention.

FIG. 5 is a schematic diagram of the English vocabulary learning according to the second embodiment of the invention.

FIG. 6 is a flowchart of an English vocabulary learning method according to the third embodiment of the invention.

FIG. 7 is a schematic diagram of the English vocabulary learning according to the third embodiment of the invention.

FIG. 8 is another schematic diagram of the English vocabulary learning according to the third embodiment of the invention.

FIG. 9 is a flowchart of an English vocabulary learning method according to the fourth embodiment of the invention.

FIG. 10 is a schematic diagram of the English vocabulary learning according to the fourth embodiment of the invention.

FIG. 11 is a flowchart of an English vocabulary learning method according to the fifth embodiment of the invention.

FIG. 12 is a schematic diagram of the English vocabulary learning according to the fifth embodiment of the invention.

FIG. 13 is another schematic diagram of the English vocabulary learning according to the fifth embodiment of the invention.

FIG. 14 is a flowchart of an English vocabulary learning method according to the sixth embodiment of the invention.

FIG. 15 is a schematic diagram of the English vocabulary learning according to the sixth embodiment of the invention.

### DESCRIPTION OF EMBODIMENTS

An English word may contain a plurality of combinations of meaningful words. If such combinations can be used to deepen the impression of the English word, the English word can thus be easily memorized. In order to make the present invention more understandable, embodiments are described below as the examples to prove that the invention can actually be realized. People ordinarily skilled in the art can realize the following embodiments with a computer program and use a computer accessible storage medium storing the computer program to enable a computer to execute the steps and go through the English vocabulary learning method in electronic automation.

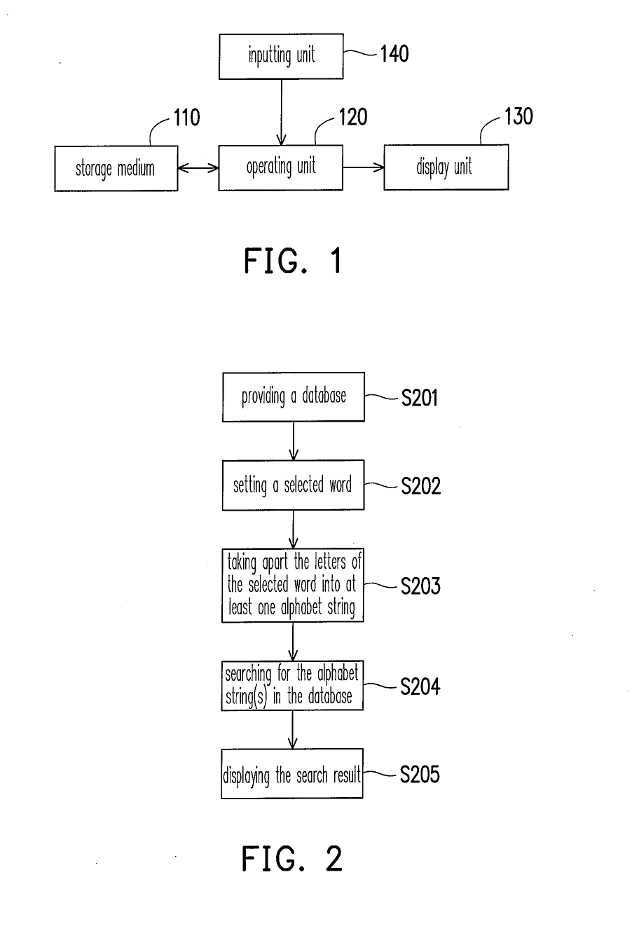

FIG. 1 is a block diagram of an apparatus for learning English vocabulary according to the first embodiment of the invention, Referring to FIG. 1, the English vocabulary learning apparatus includes a storage medium 110, an operating unit 120, a display unit 130 and an inputting unit 140. The operating unit 120 searches for relevant vocabulary in the storage medium 110 and displays the search results on the display unit 130. The display unit 130 may be a screen. The inputting unit 140 may be a keyboard and a mouse.

The storage medium 110 is used for storing a database. The database contains a plurality of vocabulary, and the number of the vocabulary is equivalent to the number of the vocabulary in a dictionary. The storage medium 110 may be a hard disk, a memory card or an optical disk. The operating unit 120 is used to proceed with the action of taking apart a selected word, namely, taking the selected word apart into at least one alphabet string. The selected word may be set by the users through the inputting unit 140 or selected from the storage medium 110 through the operating unit 120 as the selected word. The operating unit 120 searches in the database to check whether the said alphabet string(s) exist(s) in the database.

FIG. 2 is a flowchart of an English vocabulary learning method according to the first embodiment of the invention. The following further introduces the detailed steps of the English vocabulary learning method provided by the present invention along with the foregoing English vocabulary learning apparatus described in the above embodiments.

Referring to both FIGS. 1 and 2, a database containing a plurality of English vocabulary stored in the storage medium 110 is provided (a step S201). People ordinarily skilled in the art may build up the database by any means. They may input all the vocabulary from the Oxford English Dictionary word by word, or find some English vocabulary on the internet and automatically input the vocabulary to the database by means of a program collecting more and more vocabulary for the database.

Moreover, the vocabulary in the database can be further ranked to comply with different needs. For instance, all the vocabulary in the database may be ranked based on the English vocabulary in common use for students of different school ages announced by the Ministry of Education of Taiwan R.O.C. The vocabulary may also be ranked according to the frequency of usage depending upon the demands of the users. Besides, the vocabulary in the database may be listed in the alphabetical order as in most dictionaries, starting from the words beginning with an “a”.

Step S202 is setting a selected word. The users may set a selected word through the inputting unit 140 and input the same to the operating unit 120. The users may also opt to use the operating unit 120 to select automatically a word from the database to proceed with the action of taking apart the word. In other words, if no condition is set, the first listed word is selected from the database and taken apart, and then the second listed word is further selected to be taken apart. The rest of the words in the database are likewise selected and taken apart one by one until all the words are thus acted upon. In addition, the users may also set a study scope by controlling the operating unit 120 through the inputting unit 140 and select words one by one within the set study scope from the database.

When the operating unit 120 is executing a step S203, the operating unit 120 takes apart the selected word into at least one alphabet string. Afterwards, the operating unit 120 is used to search for the alphabet string(s) in the database of the storage medium 110 and check whether the alphabet string(s) taken apart from the selected word exist(s) in the database. Lastly, the operating unit 120 outputs the search results of a step S204 to the display unit 130 (a step S205).

Since an English word may contain combinations following certain rules, the operating unit 120 executes the step S203, takes apart the selected word into at least one alphabet string, finds the regularity among the alphabet strings and enhances the memory of the vocabulary on the users. Besides, the users may control the operating unit 120 to further refine the search results to a smaller range through the inputting unit 140. For instance, further searching for the words beginning with “a” on the first column within the search results.

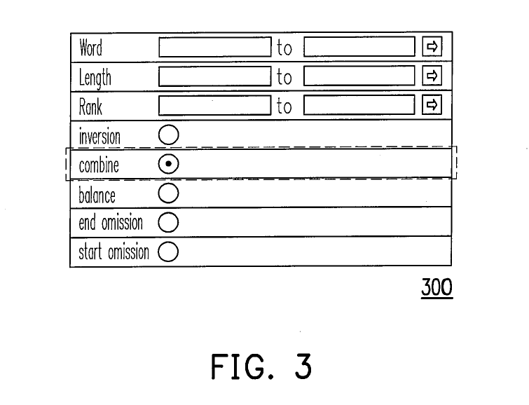

Taking FIG. 3 as an example, it is a schematic diagram of the operating frame of the English vocabulary learning method according to the first embodiment of the invention. Referring to FIG. 3, an operating frame 300 may be the default frame of the operating unit 120 displayed on the display unit 130. The operating frame 300 is used to set a study scope, as shown in the three columns on the above of the operating frame 300. The users may set the range of the vocabulary according to their own needs. They may key in “a” and “b” respectively in the two blanks on the vocabulary column, which means the search result covers all the vocabulary from the words beginning with “a” to those beginning with “b” in the database. Or the users may simply key in the blanks certain words that they wish to consult on the vocabulary column. Additionally, the length column is used to set the length of a searched word, and the rank column is used to set the level of difficulty of a searched word. The three columns on the above of the operating frame 300 are optional depending upon the users' needs. The users may set only one range, or a plurality of ranges, or even no range.

Still referring to FIG. 3, next, the users may click on one of the five columns on the operating frame 300 to choose one of the five listed vocabulary learning methods. The users may click on the “combination” column to find out the vocabulary corresponding with the selected learning method within the vocabulary covered in the set study scope. However, the operating frame 300 only serves to facilitate illustration, and the present embodiment does not limit the range of the operating frame 300. The other English vocabulary learning methods, “inversion”, “combination”, “balance”, “end omission” and “start omission”, are described in detail with the following examples. To facilitate illustration, it is assumed that in the following embodiments the users choose to the select vocabulary from the database through the operating unit 120 to proceed with different English vocabulary learning methods.

In other words, “the selected words” are selected from the database and set one by one through the operating unit 120. The users do not need to key in the selected words.

People ordinarily skilled in the art can understand and infer the other alternative according to the spirit of the present invention and the teaching and demonstration of the following embodiments, wherein the users set the selected words by themselves.

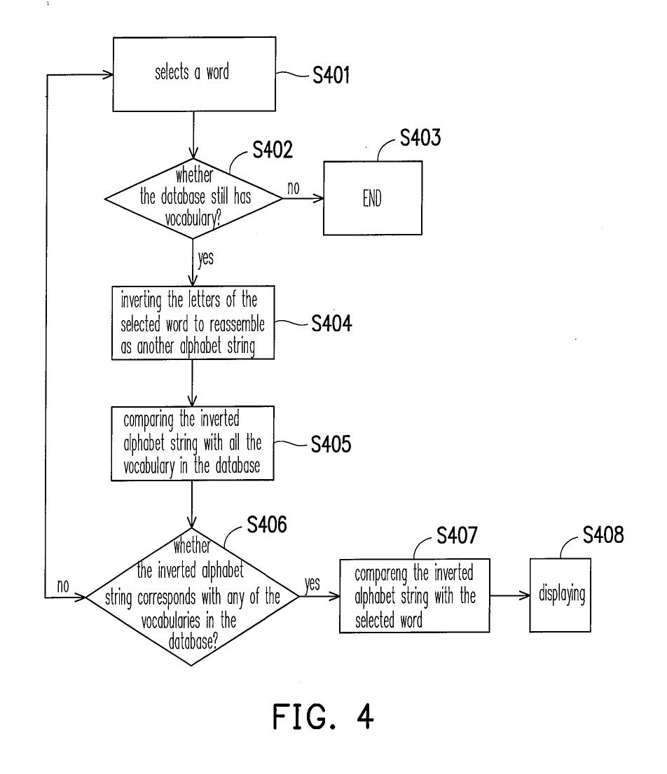

FIG. 4 is a flowchart of an English vocabulary learning method according to the second embodiment of the invention. Referring to FIG. 4, the “inversion” method is demonstrated on the letters of the selected words in the present embodiment. First, the operating unit 120 executes step S401 and selects a word in the order of the vocabulary of the database. The operating unit 120 retrieves a word from the database in the storage medium 110 to set it as “the selected word”. Further, when the user has set a study scope, the selected word is selected from the vocabulary within the study scope to be further taken apart. Moreover, before a next word is selected from the database, the operating unit 120 first checks the database to see if all the vocabulary has already been selected (step S402). If all the vocabulary has already been selected, the searching action is terminated (step S403); if not, the operating unit 120 continues selecting the next word to execute the next action.

After a word selected from the database is inputted to the operating unit 120, the letters of the selected word are inverted to reassemble as another alphabet string (step S404). The step S404 exchanges the position of the first right letter with the position of the first left letter, and the position of the second right letter with the position of the second left letter, likewise for all the rest of the letters to obtain an inverted alphabet string.

Afterwards, the inverted alphabet string is compared with all the vocabulary in the database (step S405) to determine whether the inverted alphabet string corresponds with any of the vocabularies in the database (step S406). That is, to determine whether an inverted alphabet string is a meaningful word. If the inverted alphabet string exists in the database, the inverted alphabet string is then compared with the selected word (step S407). If the inverted alphabet string is the same as the selected word, the search result displayed on the display unit is specifically marked. Finally, the inverted alphabet string and the corresponding selected word are outputted to the display unit (step S408).

For example, the selected word “raw” is inverted as “war” and searched for to check whether “war” exists in the database. Since “war” is a meaningful word, a corresponding word can be found in the database to match the alphabet string. Lastly, “raw” and “war” are displayed on the display unit.

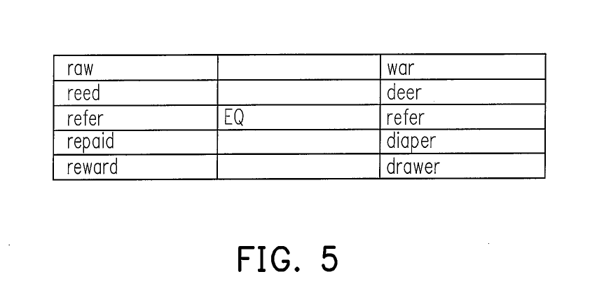

FIG. 5 is a schematic diagram of the English vocabulary learning according to the second embodiment of the invention. Referring to FIG. 5, it is an excerpt from the actual search results of the present embodiment. The left column is the selected word, the right column is the alphabet string inverted from the selected word on the left column, and all the listed alphabet strings are meaningful words. If an alphabet string from the inversion is the same as the selected word inputted, then the middle column is marked with “EQ”. Taking the selected word “refer” as an example, its inverted word is also “refer”. Hence, the middle column is marked with “EQ”, which means the word obtained from inversion is the same as the original selected word.

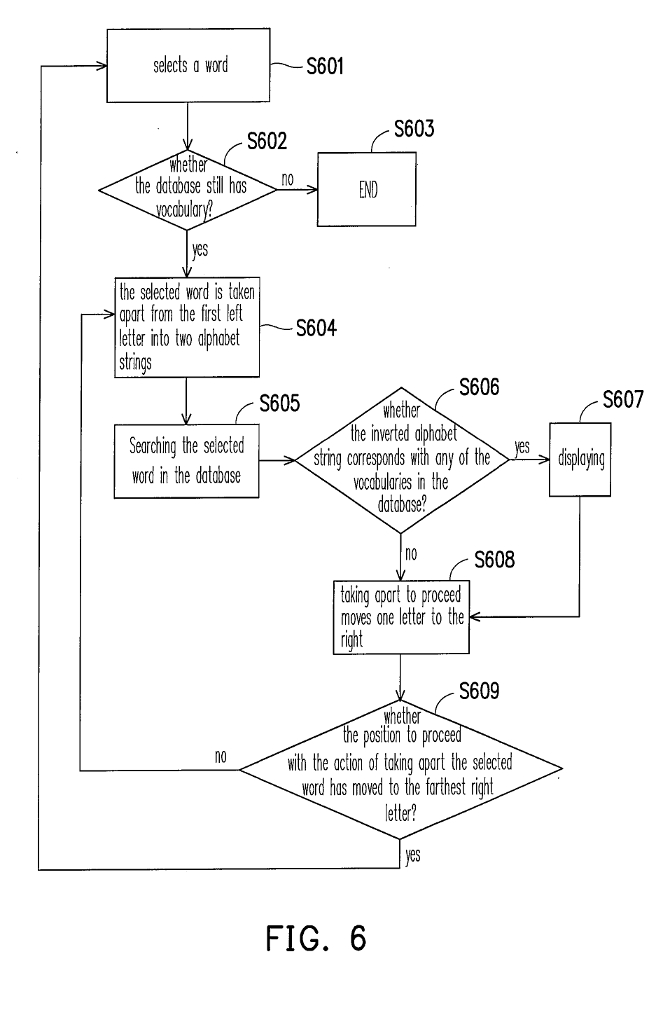

FIG. 6 is a flowchart of an English vocabulary learning method according to the third embodiment of the invention. Referring to FIG. 6, it shows an English vocabulary learning method, which “combines” the letters of the selected word in the present embodiment. Steps S601-S603 of the said method are the same or similar to the steps S401-S403. Therefore, the steps S601-S603 are not to be described in detail herein.

In step S604, the selected word is taken apart from the first left letter one by one into two alphabet strings (the step S604). The selected word “butterfly” may be taken apart from the first left letter as the first alphabet string “b” and the second alphabet string “utterfly”.

Afterwards, the two alphabet strings taken apart from the selected word are searched for in the database (step S605) to determine whether they match with any of the vocabularies in the database (step S606). If they do, the two alphabet strings and their corresponding vocabulary are outputted to and displayed on the display unit (step S607). In step S608, the position for the action of taking apart to proceed moves one letter to the right (i.e. the second left letter) to continue dividing the selected word.

Then, it is determined whether the position to proceed with the action of taking apart the selected word has moved to the farthest right letter (step S609). If the position has not moved to the farthest right letter, the selected word is further taken apart into two alphabet strings (the step S604) until the position has moved to the farthest right letter.

Again, taking the selected word “butterfly” as an example, it is taken apart from the first left letter into “b” and “utterfly”. However, the two alphabet strings do not match any of the vocabularies in the database. The position to proceed with taking apart the selected word thus moves one letter to the right and the selected word “butterfly” is taken apart into “bu” and “tterfly”. However, the two alphabet strings still do not match any of the vocabularies in the database. The position continues moving one letter to the right at one time until the selected word “butterfly” is taken apart into “butter” and “fly”, which are found to match with the corresponding vocabularies in the database.

Moreover, if the position to proceed with taking apart has moved to the farthest right letter, but the selected word still cannot be taken apart into two meaningful alphabet strings, the next word in order will be selected from the database (the step S601). Additionally, one word may be taken apart into different combinations of two alphabet strings. Therefore, after the step S607, depending on the setting set by the user, the step S608 may be executed to continue searching for other possible combinations of the alphabet strings, or the step S601 may be executed to input the next selected word to proceed with the taking apart and the comparison.

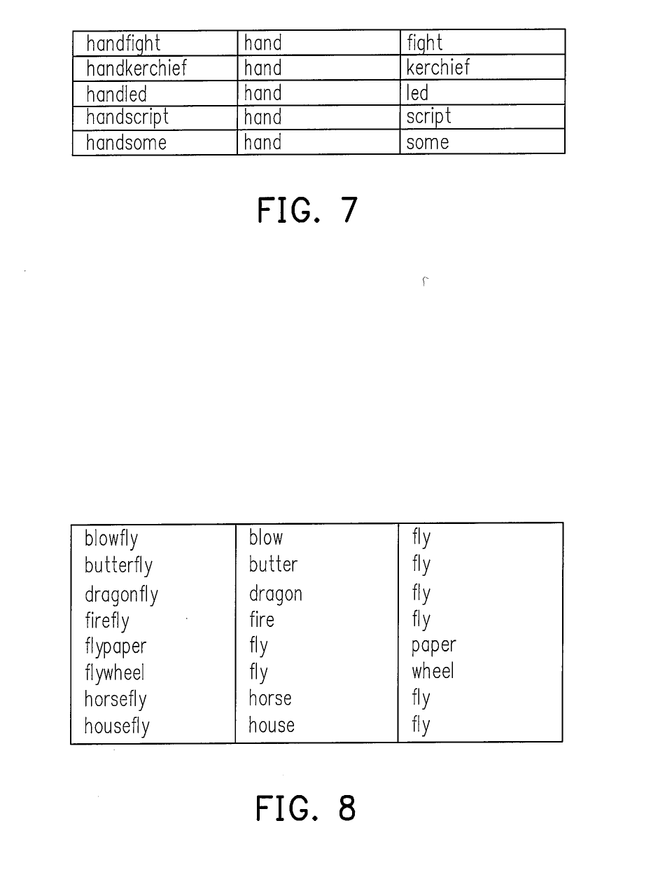

In order to make the foregoing principles more comprehensible, another embodiment is described in detail to illustrate in the following. FIG. 7 is a schematic diagram of the English vocabulary learning according to the third embodiment of the invention. Referring to FIG. 7, it is an excerpt of the results from taking apart the selected words into two meaningful words. The left column is the selected word; the middle column and the right column are the two alphabet strings from taking apart the selected word on the left column, and these alphabet strings are meaningful words. The selected word “handsome” may be taken apart into two meaningful alphabet strings, “hand” and “some”.

It is noted that the users can further search for the vocabulary they need among the search results depending on the actual situation. For instance, FIG. 8 is a schematic diagram of the English vocabulary learning according to the third embodiment of the invention. Referring to FIG. 8, it shows the search results are further searched to find out the vocabulary related to “fly” in the database. Hence, any of the original search results containing “fly” is displayed respectively either on the middle column or on the right column.

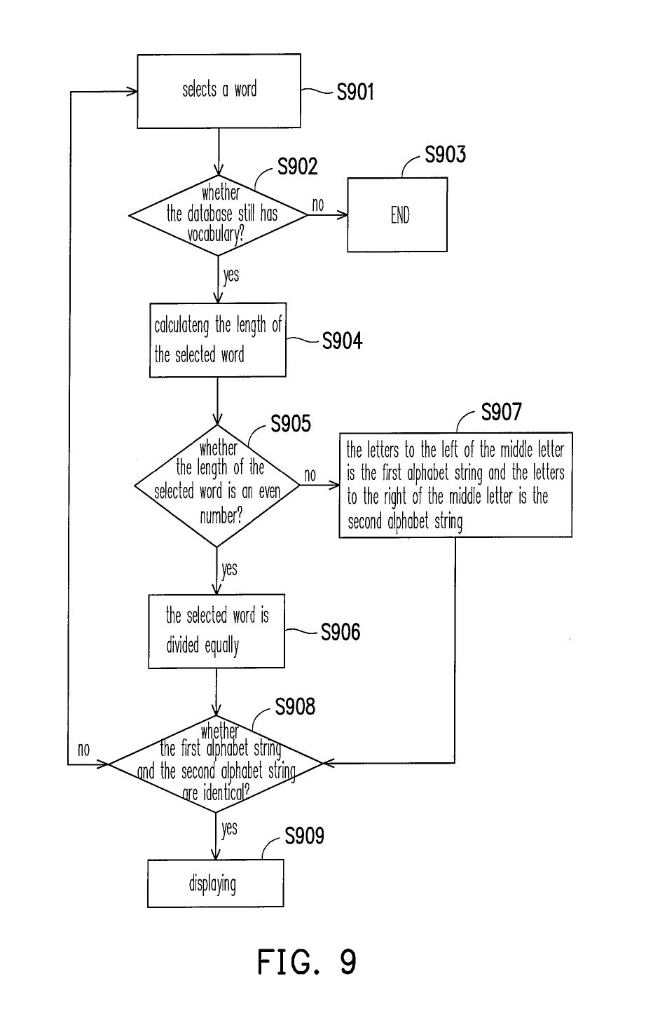

FIG. 9 is a flowchart of an English vocabulary learning method according to the fourth embodiment of the invention. Referring to FIG. 9, the present embodiment shows an English vocabulary learning method named “balance”, which means to locate two identical alphabet strings on the right and the left sides of the selected word. Steps S901-S903 of the said method are the same or similar to the steps S401-S403. Therefore, the steps S901-S903 are not to be described in detail herein.

After a word is selected as the selected word, the length of the selected word is calculated in step S904. Next, it is determined whether the length of the selected word is an even number (step S905). If the length is an even number, the selected word is divided equally (step S906). That is, the selected word is divided in the middle, and the letters on the left and on the right are the first alphabet string and the second alphabet string. Taking the selected word “murmur” as an example, after calculating its length as an even number, the selected word is divided equally into the first alphabet string “mur” and the second alphabet string “mur”.

If the length of the selected word is an odd number, the letters to the left of the middle letter is the first alphabet string and the letters to the right of the middle letter is the second alphabet string (step S907). Taking the selected word “magma” as an example, after calculating its length as an odd number, the middle letter “g” is set as the divide, and the word is taken apart into the first alphabet string “ma” on the left and the second alphabet string “ma” on the right. Afterwards, it is determined whether the first alphabet string and the second alphabet string are identical (step S908). If identical, the two alphabet strings are displayed on the display unit (step S909). If not identical, the next word is further selected as the selected word (the step S901).

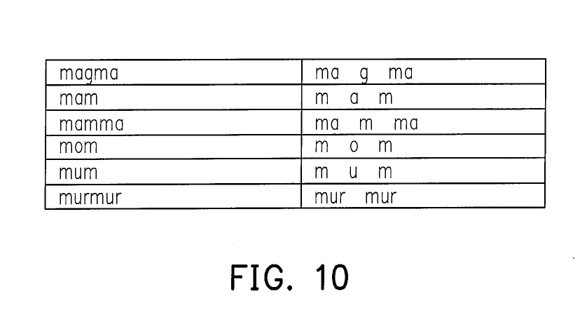

For instance, FIG. 10 is a schematic diagram of the English vocabulary learning according to the fourth embodiment of the invention. Referring to FIG. 10, the left column is the selected word, the right column are the alphabet strings on the left and on the right from equally dividing the selected word, and the alphabet strings are separated with spaces.

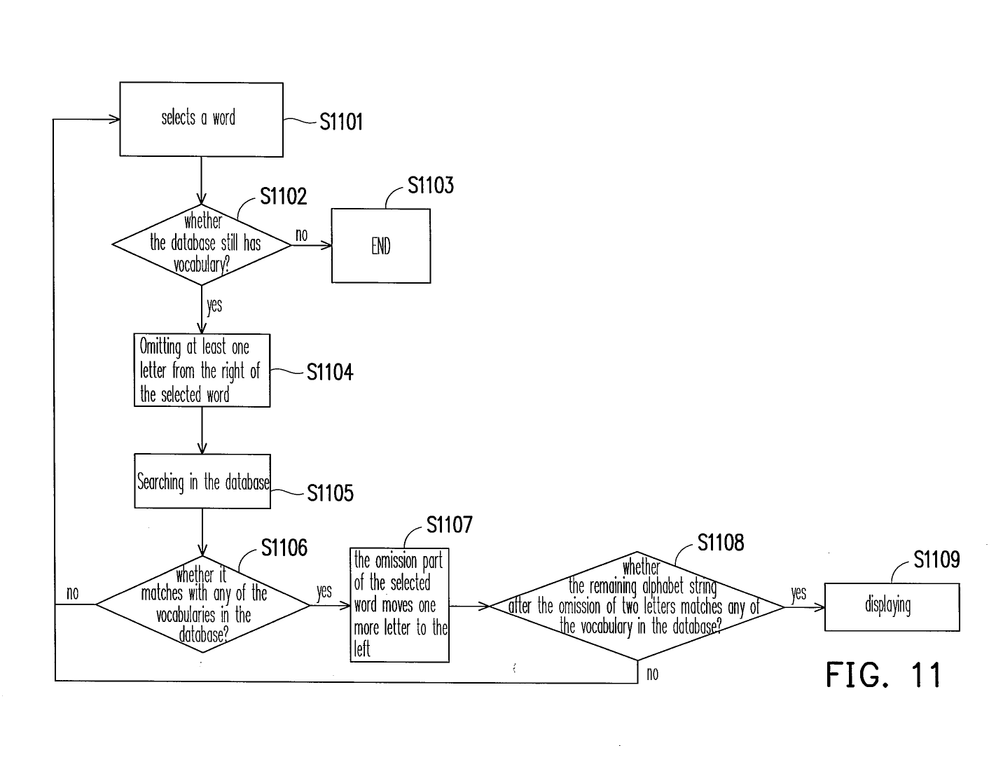

FIG. 11 is a flowchart of an English vocabulary learning method according to the fifth embodiment of the invention. Referring to FIG. 11, the end letter(s) of the selected word is/are omitted according to the English vocabulary learning method named “end omission” in the present embodiment. A plurality of end letters is omitted from the selected word to obtain a remaining alphabet string to be determined whether it is a meaningful word. Steps S1101-S1103 of the said method are the same or similar to the steps S401-S403. Therefore, the steps S1101-S1103 are not to be described in detail herein.

After a word is selected as the selected word, in step S1104 at least one letter from the right of the selected word is omitted to obtain a remaining left alphabet string. For example, after omitting the first right letter “y” from the selected word “many”, “man” is the remaining alphabet string. Next, the remaining left alphabet string is searched for in the database (step S1105) and determined whether it matches with any of the vocabularies in the database (step S1106).

If it does, the omission part of the selected word moves one more letter to the left and the remaining part is the second alphabet string (step S1107). Then it is further determined whether the remaining alphabet string after the omission of two letters matches any of the vocabularies in the database (step S1108). For instance, after the selected word “many” is omitted one letter on the right, the remaining alphabet string “man” exists in the database. Therefore, the omission part of the selected word moves one more letter to the left and the second alphabet string “ma” is obtained. Then, the second alphabet string “ma” is determined whether it exists in the database.

Finally, if the second alphabet string is also a meaningful string (the step S1108), the first alphabet string from the omission of the first right letter, the second alphabet string from the omission of the first two right letters and their corresponding vocabularies are displayed on the display unit 130 (step S1109). Further, if the foregoing second alphabet string after the omission of the first two letters on the right does not exist in the database, the second alphabet string is not displayed on the display unit, which means the column remains blank.

It is noted that the omitted letters in the step S1104 may be two right letters omitted at one time depending on the actual situation. The present embodiment is described to facilitate explanation and not intended to limit the number of omitted letters. Besides, in the embodiment any alphabet string matches with the vocabulary in the database can be displayed on the display unit 130 (the step S1109) after the step S1106. The steps S1107 and S1108 may either be executed repetitively until the selected word has already been omitted to the last letter or be determined based on the actual situation. The number of the omission of letters is not limited herein.

For instance, taking the word “tooth” for example, after executing the step S1104, the alphabet string “toot” is obtained and “toot” exists in the database. It may be determined depending on the actual situation either the results from the execution so far are displayed on the display unit 130 or the step S1107 is carried on to obtain another alphabet string “too”. The step S1107 may also be executed repetitively to obtain yet another alphabet string “to” and further find both “too” and “to” exist in the database.

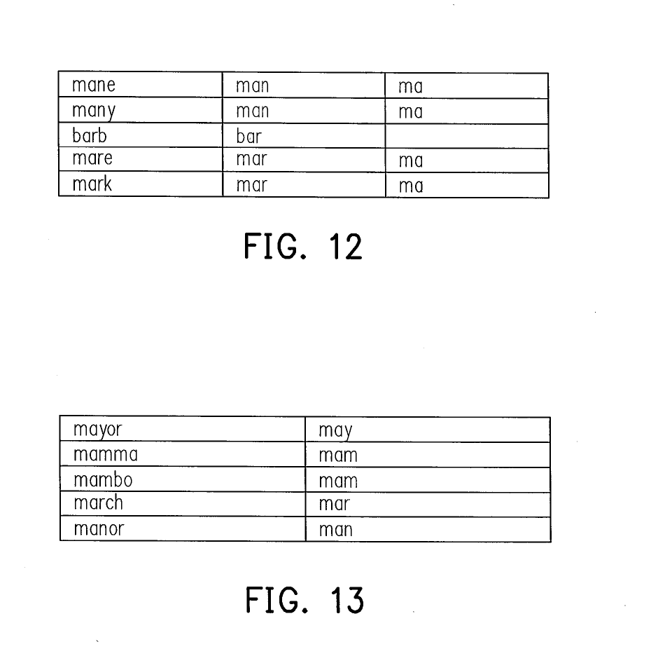

In order to express the foregoing concepts more clearly, simple drawings are used to further explain in the following. FIG. 12 is a schematic diagram of the English vocabulary learning according to the fifth embodiment of the invention. Referring to FIG. 12, the left column is the selected word, the middle column is the remaining alphabet string after omitting the first right letter from the selected word on the left column, and the right column is the remaining second alphabet string after omitting one right letter from the alphabet string on the middle column. If the remaining alphabet string after further omitting one letter from the right of the alphabet string on the middle column does not exist in the database, the corresponding right column is left blank.

In addition, the number of the omitted letters from the right may be two. FIG. 13 is a schematic diagram of the English vocabulary learning according to the fifth embodiment of the invention. Referring to FIG. 13, the left column is the selected word, the right column is the remaining alphabet string after omitting two letters from the right at one time, and all the listed alphabet strings can be found in the database.

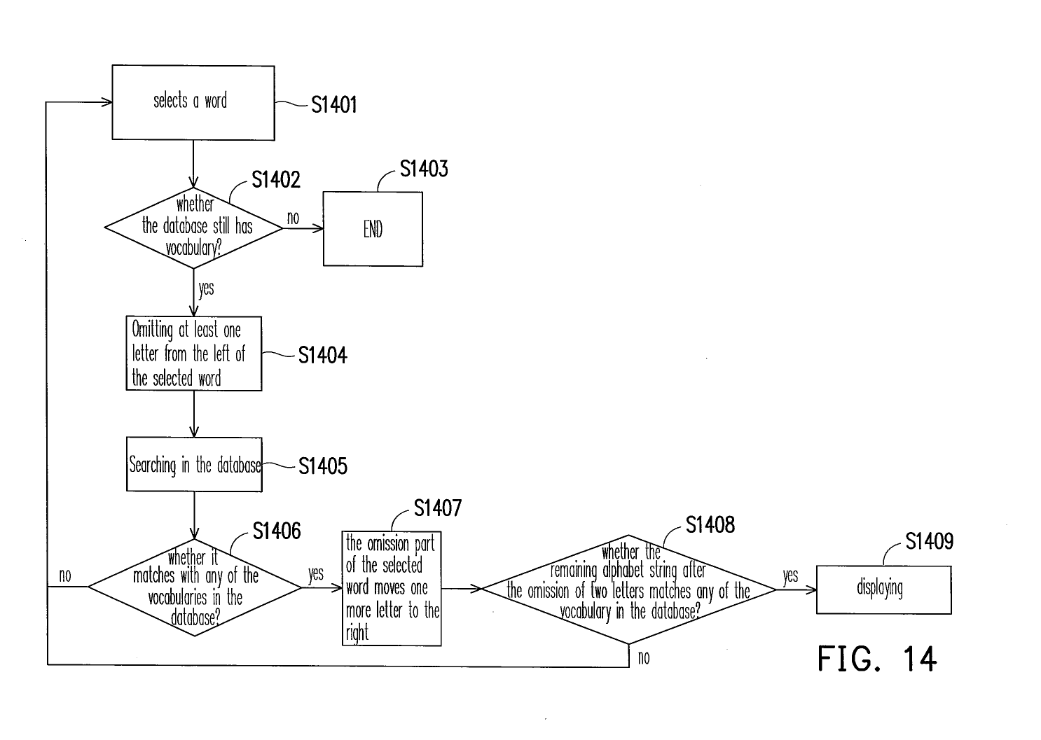

FIG. 14 is a flowchart of an English vocabulary learning method according to the sixth embodiment of the invention. Referring to FIG. 14, it shows the English vocabulary learning method named “start omission” in the present embodiment, wherein a plurality of beginning letters is omitted from the selected word, and the remaining alphabet string is then determined whether it is a meaningful word. Steps S1401-S1409 are similar to the steps S1101-S1109 of the fifth embodiment. The difference between the steps S1401-S1409 and the steps S1101-S1109 is that the step S104 of the fifth embodiment is omitting at least one letter from the end of the selected word, and the step S1404 of the present embodiment is omitting at least one letter from the start of the selected word. The rest of two sets of steps are similar; hence they are not to be reiterated herein.

In the step S1404, the first left letter of the selected word is omitted to obtain a remaining right alphabet string. If the remaining right alphabet string exists in the database, the step S1407 is executed to further omit one letter from the left of the selected word. For example, one letter from the left of the word “bowing” is omitted to obtain an alphabet string “owing” and the alphabet string “owing” exists in the database. Hence, the step S1407 is executed to obtain the second alphabet string “wing”.

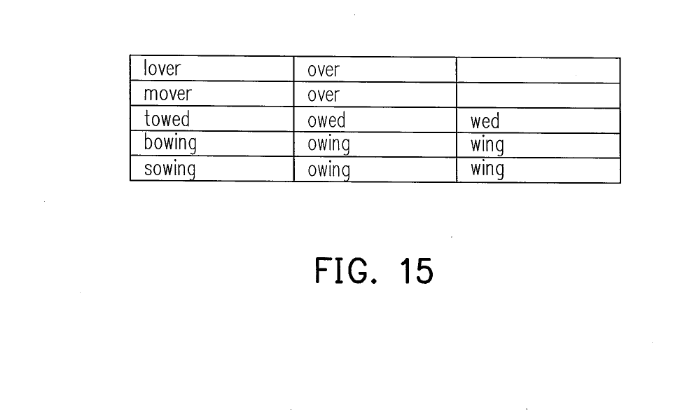

In order to express the foregoing concepts more clearly, simple drawings are used to further explain in the following. FIG. 15 is a schematic diagram of the English vocabulary learning according to the sixth embodiment of the invention. Referring to FIG. 15, the left column is the selected word, the middle column is the remaining alphabet string after omitting the first left letter from the selected word, and the right column is the second remaining alphabet string after omitting one letter from the left of the alphabet string on the middle column. If the remaining alphabet string after further omitting one letter from the left of the alphabet string on the middle column does not exist in the database, its corresponding right column is left blank.

It is noted that if the users apply the learning methods in the foregoing embodiments to memorize the English vocabulary, the methods can help deepen the impression of the English vocabulary and enhance the memory of the vocabulary in the user's mind. If the users further apply association along with the learning methods to memorize the English vocabulary, much more learning efficiency can be achieved for relatively less effort. Taking the foregoing second embodiment for example, the word “deer” is inverted into another word “reed”. The two words, “deer” and “reed”, can be memorized simultaneously if associated together as in “A deer is eating reeds.” Such association between the words helps enhance the memory of them.

In summary, the English vocabulary learning methods provided by the present invention include at least the following advantages:

1. The users may set their own study scope to search for the relevant combinations of the English vocabulary within that study scope so as to deepen their learning impression, enhance their memory of the vocabulary and not easily confuse one word with another.

2. According to the invention, the teachers can compile interesting learning methods more systematically when they arrange their teaching materials and the comprehensiveness of the vocabulary covered can be increased.

Although the present invention has been disclosed above by the preferred embodiments, they are not intended to limit the present invention. Anybody skilled in the art can make some modifications and alteration without departing from the spirit and scope of the present invention. Therefore, the protecting range of the present invention falls in the appended claims.

What is claimed is:

1. An English vocabulary learning method comprising:
providing a database, the database comprising a plurality of words;
receiving a command;
providing a selected word;
taking apart the letters of the selected word into at least one alphabet string;
searching for the alphabet string(s) in the database to obtain a search result; and
displaying the search result.

2. The English vocabulary learning method of claim 1, wherein the steps of taking apart the selected word comprise:
inverting the order of the letters in the selected word to reassemble as the alphabet string;
wherein if the database containing the vocabulary corresponding with the alphabet string, displaying the selected word and the alphabet string.

3. The English vocabulary learning method of claim 1, wherein the alphabet string comprises a first alphabet string and a second alphabet string, the steps taking apart the letters of the selected word according to the command comprising:
selecting the left section of the selected word as the first alphabet string; and
selecting the remaining letters of the selected word as the second alphabet string;
wherein if the database contains the vocabularies corresponding with the first alphabet string and the second alphabet string, displaying the selected word, the first alphabet string and the second alphabet string.

4. The English vocabulary learning method of claim 1, wherein the alphabet string comprises a first alphabet string and a second alphabet string, the steps taking apart the letters of the selected word according to the command comprising:
dividing equally the selected word into the first alphabet string and the second alphabet string;
wherein if the first alphabet and the second alphabet string are identical, displaying the selected word, the first alphabet string and the second alphabet string.

5. The English vocabulary learning method of claim 4, wherein the steps of equally dividing the selected word comprise:
calculating the length of the selected word;
if the length being an even number, dividing equally the selected word into the letters on the right and the letters on the left as the first alphabet string and the second alphabet string; and
if the length being an odd number, dividing the selected word along the middle letter into the letters on the left and the letters on the right as the first alphabet string and the second alphabet string.

6. The English vocabulary learning method of claim 1, wherein the step taking apart the selected word comprises omitting at least one letter from the right of the selected word to obtain the alphabet string.

7. The English vocabulary learning method of claim 6, wherein if the database contains the vocabulary corresponding with the alphabet string, displaying the selected word and the alphabet string.

8. The English vocabulary learning method of claim 6, wherein the steps of taking apart the selected word further comprise:
if the alphabet string corresponding with one of the vocabularies in the database, omitting at least one letter from the right of the alphabet string to obtain a second alphabet string;
wherein if the second alphabet string corresponds with one of the vocabularies in the database, displaying the selected word, the alphabet string and the second alphabet string.

9. The English vocabulary learning method of claim 1, wherein the step taking apart the selected word comprises omitting at least one letter from the left of the selected word to obtain the alphabet string.

10. The English vocabulary learning method of claim 9, wherein if the alphabet string corresponds with one of the vocabularies in the database, displaying the selected word and the alphabet string.

11. The English vocabulary learning method of claim 9, further comprising:
if the alphabet string corresponding with one of the vocabularies in the database, omitting at least one letter from the left of the alphabet string to obtain a second alphabet string;
wherein if the second alphabet string corresponds with one of the vocabularies in the database, displaying the selected word, the alphabet string and the second alphabet string.

12. The English vocabulary learning method of claim 1, further comprising:
setting a study scope; and
selecting words one by one from the database as the selected word according to the study scope.

13. A computer accessible storage medium used for storing a computer program, wherein the computer program is applied to a computer system such that the computer system executing any of the learning methods as claimed in claims 1.

14. An English vocabulary learning apparatus comprising:
a storage medium used for storing a database, the database comprising a plurality of vocabulary;
an operating unit used for setting a selected word and taking apart the letters of the selected word into at least one alphabet string and searching for the alphabet string in the database; and
a display unit used for displaying the search result from the operating unit.

15. The English vocabulary learning apparatus of claim 14, wherein the storage medium is a hard disk, a memory card or an optical disk.

16. The English vocabulary learning apparatus of claim 14, wherein the display unit is a screen.

17. The English vocabulary learning apparatus of claim 14, wherein the operating unit inverts the order of the letters in the selected word so as to reassemble as the alphabet string; and
if the database containing the vocabulary corresponding with the alphabet string, the operating unit displaying the selected word and the alphabet string on the display unit.

18. The English vocabulary learning apparatus of claim 14, wherein the alphabet string comprises a first alphabet string and a second alphabet string;
the operating unit selecting the letters on the left of the selected word as the first alphabet string, selecting the remaining letters of the selected word as the second alphabet string; and
if the database containing the vocabulary corresponding with the first alphabet string and the second alphabet string, the operating unit displaying the selected word, the first alphabet string and the second alphabet string on the display unit.

19. The English vocabulary learning apparatus of claim 14, wherein the alphabet string comprises a first alphabet string and a second alphabet string;
the operating unit dividing equally the selected word into the first alphabet string and the second alphabet string; and
if the first alphabet string and the second alphabet string being identical, the operating unit displaying the selected word, the first alphabet string and the second alphabet string on the display unit.

20. The English vocabulary learning apparatus of claim 19, wherein the operating unit calculates a length of the selected word;
if the length being an even number, the operating unit dividing equally the selected word into the letters on the left and the letters on the right as the first alphabet string and the second alphabet string; and
if the length being an odd number, the operating unit dividing the selected word along the middle letter into the letters on the left and the letters on the right as the first alphabet string and the second alphabet string.

21. The English vocabulary learning apparatus of claim 14, wherein the operating unit omits at least one letter from the right of the selected word to obtain the alphabet string.

22. The English vocabulary learning apparatus of claim 21, wherein if the database contains the vocabulary corresponding with the alphabet string, the operating unit displaying the selected word and the alphabet string on the display unit.

23. The English vocabulary learning apparatus of claim 21, wherein if the alphabet string corresponds with one of the vocabularies in the database, the operating unit omitting at least one letter from the right of the alphabet string to obtain a second alphabet string; and
if the second alphabet string corresponding with one of the vocabularies in the database, the operating unit displaying the selected word, the alphabet string and the second alphabet string on the display unit.

24. The English vocabulary learning apparatus of claim 14, wherein the operating unit omits at least one letter from the left of the selected word to obtain the alphabet string.

25. The English vocabulary learning apparatus of claim 24, wherein if the alphabet string corresponds with one of the vocabularies in the database, the operating unit displaying the selected word and the alphabet string on the display unit.

26. The English vocabulary learning apparatus of claim 24, wherein if the alphabet string corresponds with one of the vocabularies in the database, the operating unit omitting at least one letter from the left of the alphabet string to obtain a second alphabet string; and
if the second alphabet string corresponding with one of the vocabularies in the database, the operating unit displaying the selected word, the alphabet string and the second alphabet string on the display unit.

27. The English vocabulary learning apparatus of claim 14, wherein the operating unit further sets a study scope and selects words one by one from the database as the selected words according to the study scope.
